(19) United States
(12) Patent Application Publication
(10) Pub. No.: US 2026/0086268 A1
(43) Pub. Date: Mar. 26, 2026

(54) MULTIFUNCTIONAL AB ADHESIVE COMBINED WITH BLUE LIGHT BLOCKING AND ANTI-PEEP STRUCTURE

(71) Applicant: WTL Technology Shenzhen CO., LTD., Shenzhen (CN)

(72) Inventors: Tak Nam LIU, Shenzhen (CN); Siu Yin LIU, Shenzhen (CN)

(21) Appl. No.: 18/945,606

(22) Filed: Nov. 13, 2024

(30) Foreign Application Priority Data
Sep. 23, 2024 (CN) 202411326117.9

(51) Int. Cl. G02B 1/04; G02B 1/14; G02B 1/16

(52) U.S. Cl. CPC G02B 1/04; G02B 1/14; G02B 1/16

(57) ABSTRACT

The present application discloses a multifunctional AB adhesive combined with a blue light blocking and anti-peep structure, including a first PET release film, an anti-peep blue light structural layer, an anti-static coating, an impact resistant hole structure silica gel layer and a second PET release film.

### CROSS-REFERENCE TO RELATED APPLICATIONS

This application is based upon and claims priority to Chinese Patent Application No. 202411326117.9, filed on Sep. 23, 2024, the entire content of which is incorporated herein by reference.

### TECHNICAL FIELD

The present application relates to the technical field of cell phone protective film, specifically a multifunctional AB adhesive combined with a blue light blocking and anti-peep structure.

### BACKGROUND

“Blue light” refers to a kind of blue visible light with a wavelength between 400-500 nanometers, commonly found in the sun and electronic devices such as cell phones, computers, televisions, etc. Long-term exposure to the blue light in this band will cause certain damage to the user's retina which is irreversible, so in order to better protect the user's eyes, the anti-blue light cell phone films were developed. These films use blue light-blocking technology to filter out harmful light and reduce potential eye strain. With the increasing awareness of protecting personal privacy, there is a growing demand for tempered films with anti-peep function, resulting in various protective products such as cell phone cases, cell phone protective soft films, cell phone protective tempered films, etc., appearing on the market. However, these kinds of protective products often have limited functionality. For instance, tempered glass films may offer blue light blocking, anti-peep, impact resistance, and high transparency, but the functionality is often somewhat singular and fails to meet all of the market's requirements.

The existing cell phone protective films have the following defects: first, the anti-blue light effect is insufficient, and in order to achieve a high blue light blocking rate, some anti-blue light films will sacrifice screen brightness, resulting in a significant darkening of the screen after pasting. This not only affects the user experience, but may also aggravate the burden on the eyes due to the use of cell phones in a low-light environment for a long time, and after the blue light is blocked, the color balance of the screen will be affected, often manifested as color distortion, yellowish or reddish. Some anti-blue light films, while blocking the blue light, can lead to significant changes in screen color temperature, deviating from the normal display range. This not only affects color accuracy, but may also be a potential threat to the user's visual health, and such chromatic aberration problem not only affects the visual effect, but may also cause discomfort to the user; second, the transmittance of the traditional anti-peep grating is generally 65-68%, which affects the brightness and clarity of the screen for users during use. For modern people who frequently use electronic payments, it is easy for store clerks to encounter the problem of not being able to read the QR code when scanning mobile payment QR codes; third, they are easy to adsorb dust, resulting in dust spots during film pasting, affecting the aesthetics and hand feel, and in serious cases, there may be undesirable conditions such as white edges caused by dust spots lifting the tempered film.

### SUMMARY

The object of the present application is to provide a multifunctional AB adhesive combined with a blue light blocking and anti-peep structure to solve the problems proposed in the above-mentioned background technology.

In order to realize the above purpose, the present application provides the following technical scheme: a multifunctional AB adhesive combined with a blue light blocking and anti-peep structure, including an anti-peep blue light structural layer, a high-transparency PET base layer fixedly connected to an outer wall one side of the said anti-peep blue light structural layer, an OCA layer provided on one side of the high-transparency PET base layer, and a first PET release film provided on one side of the OCA layer.

As a further technical scheme of the present application, an anti-static coating is provided on an outer wall of the other side of the said anti-peep blue light structural layer, a high-transparency PET film is provided on one side of the anti-static coating, an impact resistant hole structure silica gel layer is provided on one side of the high-transparency PET film, and a second PET release film is provided on one side of the impact resistant hole structure silica gel layer.

As a further technical scheme of the present application, the said OCA layer is made of high-transparency OCA adhesive.

As a further technical scheme of the present application, the said high-transparency PET base layer is a film made of polyethylene glycol terephthalate polymer under bidirectional stretching, which serves as the substrate of the anti-peep layer structure resin.

As a further technical scheme of the present application, the said anti-peep blue light structural layer is first coated with a layer of structural resin on the high-transparency substrate, which is mainly composed of UV monomer 3, epoxy acrylate resin and UV molding resin, and then using a mold with a grating texture to imprint it with a shape of long strip groove, followed with a filled procedure using a black resin mixed with a blue light solution, which consists of a fluorescent powder, an organic light absorber, an ultraviolet absorber, a resin and an organic filler, and the anti-peep blue light layer is formed after UV curing.

As a further technical scheme of the present application, the distance between the groove bottom of the anti-peep texture in the anti-peep blue light structural layer and the bottom wall of the connecting layer is 5 μm, the spacing between adjacent long strip-shaped grooves is 35-45 μm, and the depth of the long strip-shaped groove is 75 μm.

As a further technical scheme of the present application, the mass percentage content of each component in the anti-peep blue light structural layer is: 10-15% fluorescent powder, 0-10% organic light absorber, 0-10% ultraviolet absorber, 15-20% organic filler, and the remaining amount is black resin.

As a further technical scheme of the present application, the anti-static coating includes a composition of cations and non-ions.

As a further technical scheme of the present application, the coating method is to attach the composition to the PET surface, then undergoes a thermal curing process, ultimately forming a layer of anti-static coating on the PET.

As a further technical scheme of the present application, the silica gel which is used in the impact resistant hole structure silica gel layer is mainly composed of methyl vinyl MQ resin, octamethylcyclotetrasiloxane, polysiloxane and fluorocarbon polymer, wherein the fluorocarbon polymer is used as an additive and can achieve a water-washing effect.

Compared to the prior art, the beneficial effects of the present application are:
1. The present application integrates an AB adhesive structure that blocks blue light and efficiently prevents peeping. This structure combines inorganic nanotechnology and polymer material composite technology, realizing precise absorption and effective shielding of blue light in a specific band of 435 nm to 440 nm, effectively curbing blue light penetration, and maintaining the smooth transmission of visible light in a wide range of 440 nm to 780 nm at the same time, ensuring that the visual experience is not affected, and minimizing the screen brightness attenuation and color temperature shift.
2. In order to further improve visual quality, the present application adopts the method of depth fusion of blue light blocking solution and black resin to back-fill the substrate, which not only enhances the performance of anti-blue light, but also makes the overall transmittance up to 73%, reducing the negative impact of the anti-peep design on screen brightness and clarity to a great extent, allowing users to obtain high-definition vision without losing eye protection effect.
3. In addition, the anti-static coating technology has been added as a protective barrier, effectively preventing the problem of dust particle adsorption due to electrostatic action during the peeling process of the release film, thereby maintaining the cleanliness and aesthetics of the screen.
4. Furthermore, the innovative hole structure design of the silica gel layer with excellent micro-dust capture ability, can easily wrap and fix micro-dust particles with a diameter less than 0.3 mm, thus fundamentally eliminating visual defects such as white edges formed by dust particles lifting the edge of the tempered film, ensuring perfect fit of the screen edge and long-lasting new.

### BRIEF DESCRIPTION OF DRAWINGS

FIG. 1 is a schematic diagram of the structure of each layer of the present application;

FIG. 2 is a first microscopic cross-sectional view of black resin mixed with a blue light blocking solution back-fill substrate in the present application;

FIG. 3 is a second microscopic cross-sectional view of black resin mixed with a blue light blocking solution back-fill substrate in the present application;

FIG. 4 is a physical property parameter diagram of anti-peep blue light of the present application;

FIG. 5 is a 380-460 nm blue light transmittance test diagram of the present application.

In which: 1. a first PET release film; 2. an OCA layer; 3. a high-transparency PET base layer; 4. an anti-peep blue light structural layer; 5. an anti-static coating; 6. a high-transparency PET film; 7. an impact resistant hole structure silica gel layer; 8. a second PET release film.

### DETAILED DESCRIPTION OF THE EMBODIMENTS

The technical solutions in the embodiments of the present application are described clearly and completely below in conjunction with the accompanying drawings in the embodiments of the present application. It should be appreciated that the described embodiments are only a part of the embodiments of the present application, not all of the embodiments. Based on the embodiments of the present application, all other embodiments obtained by a person of ordinary skill in the art without making creative labor fall within the scope of protection of the present application.

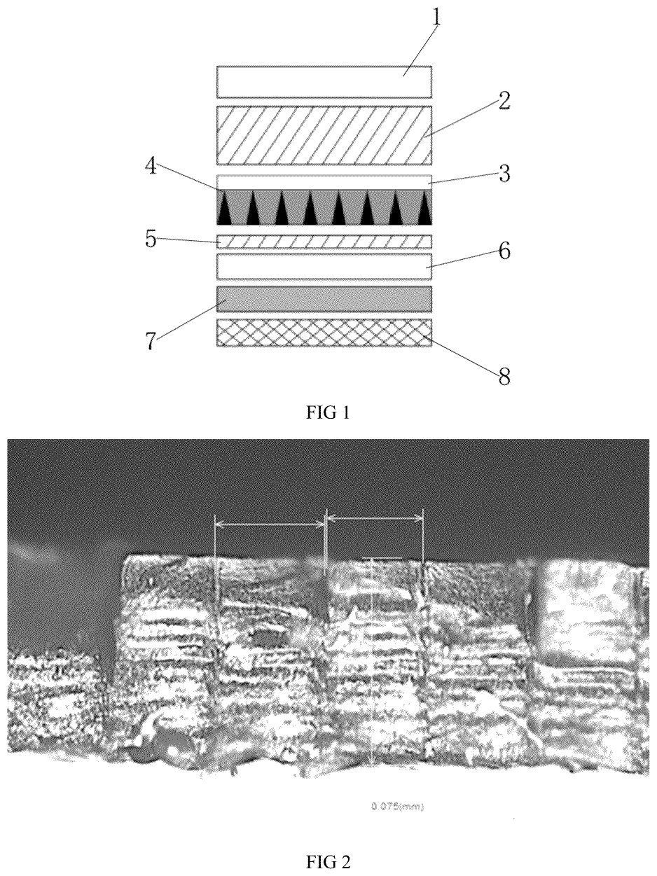

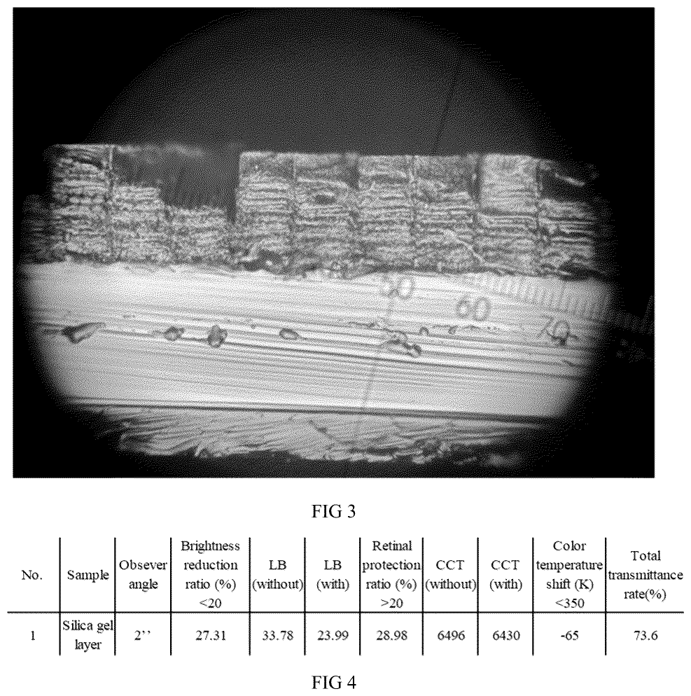

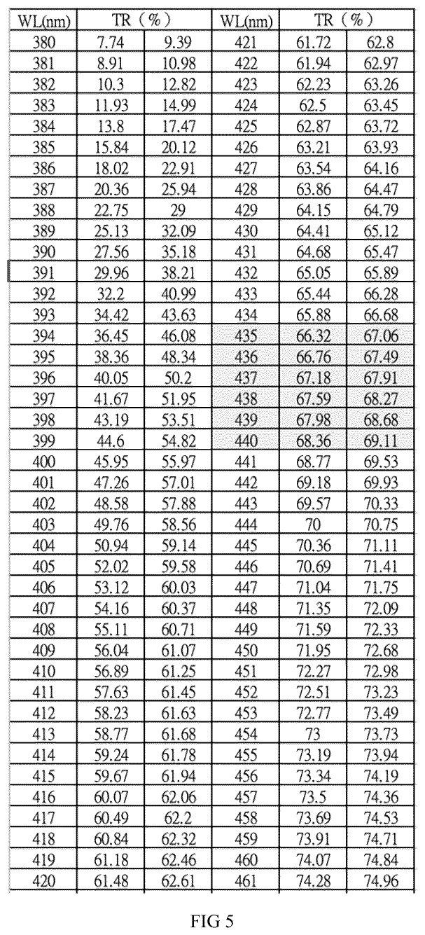

Referring to FIGS. 1-5, the present application provides an embodiment: a multifunctional AB adhesive combined with a blue light blocking and anti-peep structure, including an anti-peep blue light structural layer 4, a high-transparency PET base layer 3 fixedly connected to an outer wall of one side of the anti-peep blue light structural layer 4, an OCA layer 2 provided on one side of the high-transparency PET base layer 3, and a first PET release film 1 provided on one side of the OCA layer 2; the outer wall of the other side of the anti-peep blue light structural layer 4 is provided with an anti-static coating 5, a high-transparency PET film 6 is provided on one side of the anti-static coating 5, an impact resistant hole structure silica gel layer 7 is provided on one side of the high-transparency PET film 6, and a second PET release film 8 is provided on one side of the impact resistant hole structure silica gel layer 7.

The OCA layer 2 is made of high-transparency OCA adhesive, and the thickness of the OCA layer 2 is 230 μm.

The high-transparency PET base layer 3 is a film made of polyethylene glycol terephthalate polymer under bidirectional stretching, which serves as the substrate of the anti-peep layer structure resin, with a thickness of 23 μm.

The anti-peep blue light structure layer 4 is first coated with a layer of structural resin on the high-transparency substrate, which is mainly composed of a UV monomer 3, epoxy acrylate resin and UV molding resin, and then using a mold with a grating texture to imprint it with a shape of long strip groove, followed with a filled procedure using a black resin mixed with a blue light solution, which consists of fluorescent powder, organic light absorber, ultraviolet absorber, resin and organic filler, and the anti-peep blue light layer is formed after UV curing. Because of the reducing superposition state of one layer, the superimposition phenomenon caused by the difference in resin refractive index can be eliminated, thereby improving the transparency of the anti-peep film, the thickness of which is 90 μm.

The distance between the groove bottom of the anti-peep texture in the anti-peep blue light structural layer 4 and the bottom wall of the connecting layer is 5 μm, the spacing between adjacent long strip-shaped grooves is 35-45 μm, and the depth of the long strip-shaped groove is 75 μm.

The mass percentage content of each component in the anti-peep blue light structural layer 4 is: 10-15% fluorescent powder, 0-10% organic light absorber, 0-10% ultraviolet absorber, 15-20% organic filler, and the remaining amount is black resin.

The anti-static coating 5 includes a composition of cations and non-ions. Due to the synergistic effect, the composition exhibits not only excellent characteristics of cationic anti-static properties, but also the stability of nonionic antistatic agents; through a coating method, the composition is adhered to the PET surface, then undergoes a thermal curing process, ultimately forming a layer of anti-static coating on PET.

The silica gel which is used in the impact resistant hole structure silica gel layer 7 is mainly composed of methyl vinyl MQ resin, octamethylcyclotetrasiloxane, polysiloxane and fluorocarbon polymer, wherein the fluorocarbon polymer is used as additive and can achieve a water-washing effect. Under microscopic observation of low-viscosity silica gel, its surface is covered with many porous structures, which are advantageous for gas venting, and when the thickness of the silica gel reaches more than 60 micrometers, these pores can effectively wrap the dust.

### Operational Principle

The multifunctional AB adhesive combined with a blue light blocking and anti-peep structure provided by the present application assembles and uses a first PET release film 1, an OCA layer 2, a high-transparency PET base layer 3, an anti-peep blue light structural layer 4, an anti-static coating 5, a high-transparency PET film 6, an impact resistant hole structure silica gel layer 7 and a second PET release film 8, wherein both the first PET release film 1 and the second PET release film 8 are made of general PET polyester films, and are respectively used as optical light release film and optical heavy release film under this structure.

The OCA layer 2 is made of high-transparency OCA adhesive with high transparency and low haze, which has a minimal effect on the reflectivity of the anti-reflective film, and has high adhesion, excellent weather fastness; The light-cured OCA has good flatness and the transmittance will be improved after coating the anti-peep substrate, the thickness under this structure is 230 μm.

Both the high-transparency PET base layer 3 and the high-transparency PET film 6 are a film made of polyethylene glycol terephthalate polymer under bidirectional stretching, and the optical grade PET polyester film has the characteristics of high light transmittance, low haze, high brightness, no-yellowing, good adhesion, good flatness, no bright and dark lines, high temperature resistance, ultraviolet radiation resistance, good stiffness, burn crack resistance, not easy to break, etc. They can serve as the substrate of the anti-peep layer structure resin under this structure, with a thicknesses of 23 μm and 50 μm, respectively.

The anti-peep blue light structural layer 4 is prepared by the following procedures: coated with a layer of structural resin (mainly composed of UV monomer 3, epoxy acrylate resin, and UV molding resin) on the high-transparency substrate; embossed into a long strip-shaped groove using a mold with a grating texture, the distance between the groove bottom of the anti-peep texture and the bottom wall of the connecting layer is 5 μm, the spacing between adjacent long strip-shaped grooves is 35-45 μm, and the depth of the long strip-shaped groove is 75 μm; and then back-filled the black resin that has been mixed with a blue light solution (composed of fluorescent powder, organic light absorber, ultraviolet absorber, resin and organic filler, the mass percentage content of each component is: 10-15% fluorescent powder, 0-10% organic light absorber, 0-10% ultraviolet absorber, 15-20% organic filler, and the remaining amount is black resin), and the anti-peep blue light layer is formed after UV curing. Because of reducing superposition state of one layer, the superimposition phenomenon caused by the difference in resin refractive index can be eliminated, thereby increasing the transmittance of the anti-peep film. The thickness of the anti-peep blue light structural layer is 90 μm.

The anti-static coating 5 includes a composition of cations and non-ions, due to the synergistic effect, the composition exhibits not only excellent characteristics of cationic anti-static properties, but also the stability of nonionic antistatic agents. The composition is adhered to the PET surface by coating, then undergoes a thermal curing process, ultimately forming a layer of anti-static coating on PET, the thickness of which is 20 μm.

The impact resistant hole structure silica gel layer 7 is mainly composed of methyl vinyl MQ resin, octamethylcyclotetrasiloxane, polysiloxane and fluorocarbon polymer (an additive, achieving water-washing effect). Under a microscopic level, the surface of low-viscosity silica gel is covered with many porous structures, such pore structures are advantageous for gas venting, and when the thickness of the silica gel reaches more than 60 μm, these pores can effectively wrap the dust.

The impact resistance effect of the ordinary two-strength tempered film measured by a falling ball standard is 64 g/150 cm, while the impact resistance effect of the AB adhesive of the present application can be increased to 130 g/150 cm, ensuring a blue light blocking rate greater than 30%, accurately blocking harmful blue light in 435-440 nm band, and simultaneously ensuring the screen brightness attenuation rate less than 30% and the color temperature shift less than 350K.

It is obvious to those skilled in the art that the present application is not limited to the details of the above exemplary embodiments, and that the present application can be realized in other specific forms without deviating from the spirit or essential features of the present application. Therefore, the embodiments should be regarded as exemplary and non-limiting from any point of view, and the scope of the present application is limited by the appended claims rather than the above description, so that all variations falling within the meaning and scope of the equivalent elements of the claims are intended to be included in the present application.

What is claimed is:

1. A multifunctional AB adhesive combined with a blue light blocking and anti-peep structure, comprising an anti-peep blue light structural layer, wherein a high-transparency PET base layer is fixedly connected to an outer wall of one side of the anti-peep blue light structural layer, an OCA layer is provided on one side of the high-transparency PET base layer, and a first PET release film is provided on one side of the OCA layer.

2. The multifunctional AB adhesive of claim 1, wherein an anti-static coating is provided on an outer wall of an other side of the anti-peep blue light structural layer, a high-transparency PET film is provided on a side of the anti-static coating, an impact resistant hole structure silica gel layer is provided on a side of the high-transparency PET film, and a second PET release film is provided on a side of the impact resistant hole structure silica gel layer.

3. The multifunctional AB adhesive of claim 1, wherein the OCA layer is made of a high-transparency OCA adhesive.

4. The multifunctional AB adhesive of claim 1, wherein the high-transparency PET base layer is a film made of polyethylene glycol terephthalate polymer under bidirectional stretching, which serves as a substrate of the anti-peep layer structural resin under this structure.

5. The multifunctional AB adhesive of claim 1, wherein the anti-peep blue light structural layer is first coated with a layer of structural resin on the high-transparency PET base layer, which mainly consists of a UV monomer, an epoxy acrylate resin, and a UV molding resin, and then using a mold with a grating texture to imprint it with a shape of long strip groove, and then followed with a filled procedure using a black resin mixed with a blue light solution, which consists of a fluorescent powder, an organic light absorber, an ultraviolet absorber, a resin and an organic filler, and the anti-peep blue light layer is formed after UV curing.

6. The multifunctional AB adhesive of claim 5, wherein there is 5 μm of distance between a groove bottom of anti-peep texture in the anti-peep blue light structural layer and a bottom wall of a connecting layer, 35-45 μm of spacing between adjacent long strip-shaped grooves, and a depth of the long strip-shaped groove is 75 μm.

7. The multifunctional AB adhesive of claim 5, wherein the anti-peep blue light structural layer, counted with mass percentage, comprises: 10-15% fluorescent powder, 0-10% organic light absorber, 0-10% ultraviolet absorber, 15-20% organic filler, and the remaining amount is black resin.

8. The multifunctional AB adhesive of claim 2, wherein the anti-static coating comprises a composition of cations and non-ions.

9. The multifunctional AB adhesive of claim 8, wherein an anti-static composition is coated onto the PET surface, then undergoes a thermal curing process so as to form a layer of anti-static coating on PET.

10. The multifunctional AB adhesive of claim 2, wherein the impact resistant hole structure silica gel layer comprises a silica gel mainly consisting of methyl vinyl MQ resin, octamethylcyclotetrasiloxane, polysiloxane and fluorocarbon polymer, wherein the fluorocarbon polymer is used as an additive.
